(19) United States
(12) Patent Application Publication
(10) Pub. No.: US 2013/0098985 A1
(43) Pub. Date: Apr. 25, 2013

(54) CONTINUOUS PRINT DEVICES AND SYSTEMS

(71) Applicant: Timothy Chambers, Longmont, CO (US)

(72) Inventor: Timothy Chambers, Longmont, CO (US)

(21) Appl. No.: 13/450,281

(22) Filed: Apr. 18, 2012

Related U.S. Application Data
(60) Provisional application No. 61/476,752, filed on Apr. 18, 2011.

(51) Int. Cl. G06F 17/00

(52) U.S. Cl. CPC G06F 17/00
USPC 235/375; 271/279

(57) ABSTRACT

Continuous print devices and systems are disclosed herein. Embodiments include continuous print devices having a plurality of temporary holding sections, each of which is bounded by a moveable bottom barrier. The temporary holding sections are typically aligned vertically with each other, thus allowing print media to fall from one temporary holding section to the next temporary holding section below. The temporary holding sections are adapted to contain print jobs including unique set documents for association and packaging with medication containers during fulfillment of prescription orders. Embodiments of the continuous print system enable associated printers to maintain at least one print job in the printer's memory during order fulfillment, thereby enabling the printer to operate continuously. Warm-up or cool-down cycles of the associated printer that can be induced by delays between successive print jobs are thus eliminated during normal operation of the continuous print system.

The present application claims priority to and incorporates by reference U.S. provisional Patent Application No. 61/476,752, filed 18-Apr.-2011, having the same title and inventor as the present application.

### FIELD OF THE INVENTION

The present invention relates generally to devices and systems for continuously printing a plurality of unique set documents. More particularly, the present invention relates to devices and systems for continuously printing a plurality of unique set documents for packaging and association with at least one medication container during fulfillment of pharmacy medication prescription orders.

### BACKGROUND

Automation in the fulfillment of pharmacy medication prescription orders has increased significantly in recent years, as pharmacies seek to more efficiently and effectively process orders. For example, more efficient automation of pill counting and medication container routing have resulted in the print literature and associated packaging processes being rate limiting steps in automated prescription order fulfillment.

For example, the speed and efficiency of the fulfillment of pharmacy medication prescription orders can be significantly increased by the use of supertotes. A supertote contains a plurality of single customer, single medication container prescription orders in a single tote used to route the prescription orders around a pharmacy fulfillment center. Ordinarily, a single regular tote is used for each single customer, which is efficient when each single customer has a plurality of medication containers associated with the customer's prescription order. When a single tote is used for a single customer, single medication container prescription order, the prescription order fulfillment rate significantly decreases. Hence, a supertote having, for instance, twelve single customer, single medication container prescription orders therein will increase the prescription order fulfillment rate.

However, a bottleneck or unwanted delay can result during sorting and handling of print literature associated with packaging of the plurality of single customer, single medication container prescription orders. An operator at a packaging station may have to sort through a batch print job to identify the appropriate print literature with the specific medication container for each customer prescription order in the supertote. Alternatively, the operator at the packaging station may have to wait for the print literature associated with specific medication container for each customer prescription order to be printed and processed serially.

Additionally, even during print literature processing associated with a regular tote, even a slight delay in sending print jobs to a printer in the packaging station can cause the printer to go into standby mode, subsequently requiring a warming up period before the printer resumes operation. Repeated instances of printer standby and warm up periods can significantly decrease the prescription order fulfillment rate. Given the considerable inefficiencies and potential time delays associated with current literature printing and handling processes, it would be advantageous to design devices and systems that enable a more automated and efficient continuous printing of the print literature required for fulfillment of pharmacy medication prescription orders.

### BRIEF DESCRIPTION OF THE FIGURES

FIG. 1 is a perspective view of a print media handling device according to a first embodiment.

FIG. 2 is a close-up front perspective view of a plurality of temporary holding slots of a print media handling device according to a first embodiment.

FIG. 3 is a close-up side rear perspective view of a plurality of temporary holding slots of a print media handling device according to a first embodiment.

FIG. 4 is perspective view of a print media handling device according to a second embodiment.

FIG. 5 is a perspective view of a print media handling device according to a third embodiment.

FIG. 6 is a block diagram illustrating an exemplary architecture of a continuous print system according to an embodiment.

FIG. 7 is a block diagram of an exemplary computer system that can be utilized in various embodiments of the continuous print system.

FIG. 8 is a perspective view of an exemplary continuous print system with a print media handling device in a fully-automated bottle/vial-based medication packing station according to an embodiment.

FIG. 9 is a perspective view of an exemplary continuous print system with two print media handling devices in a regular tote/supertote-based semi-automated medication packing station according to an embodiment.

FIG. 10 is a close-up perspective view of the two print media handling devices in the exemplary continuous print system illustrated in FIG. 9 according to an embodiment.

FIG. 11 is a close-up perspective view of a feed mechanism and a one of the two print media handling devices in the exemplary continuous print system illustrated in FIG. 9 according to an embodiment.

FIG. 12 is a close-up perspective view of an alternative feed mechanism according to an embodiment.

FIG. 13 is a close-up top perspective view of a topmost temporary holding section having two print media sheets therein according to an embodiment.

### DETAILED DESCRIPTION

Embodiments of the present invention comprise print media handling devices and continuous print systems. Embodiments of the print media handling device comprise a support frame and a plurality of temporary holding sections. The support frame includes at least a left side wall and a right side wall. However, other support structures and general housing features are typically included in the support frame depending on the particular embodiment of the print media handling device. Each of the temporary holding sections are approximately vertically aligned with each other to allow print media to fall using at least some gravitational force from one temporary holding section to the next temporary holding section below.

Each of the temporary holding sections typically comprises a left barrier, a right barrier, and a moveable bottom barrier. The left barrier of each temporary holding section is typically defined at least in part by the left side wall of the support frame. Similarly, the right barrier of each temporary holding section is typically defined at least in part by the right side wall of the support frame. The moveable bottom barrier can be comprised of various structures adapted to remove or eliminate the bottom barrier of each temporary holding section and then reestablish the bottom barrier. Hence, the movement of print media from one temporary holding section to the next can be precisely controlled.

A topmost temporary holding section, which can either be considered a separate temporary holding section or the first of the plurality of temporary holding sections, receives print media from a printer via a feed mechanism. The topmost temporary holding section includes at least a first sensor adapted to read a code disposed on at least some print media sheets. The topmost temporary holding section typically also includes a second sensor adapted to count print media sheets.

Various embodiments of the print media handling device are used in conjunction with and controlled by embodiments of the continuous print system. Continuous print systems employing continuous print software and associated technology enable more automated and efficient continuous printing of the print literature required for fulfillment of pharmacy medication prescription orders. The print literature required for fulfillment of pharmacy medication prescription orders are unique set documents. A unique set document is basically a set of documents having at least some information thereon or associated therewith that differs from all other document sets. Unique set documents and the handling thereof are differentiated from the printing and handling of collated documents. While some staging and temporary holding may be required during a collating process, collated documents do not require any of type of unique association or identification with a specific object or purpose.

Embodiments of the continuous print system can perform a multitude of print literature handling and processing functions and can be used with a variety of packaging systems to significantly enhance throughput (e.g., faster per order print speeds) of the pharmacy medication prescription orders in a pharmacy operation. Moreover, in some embodiments, a multitude of the standard order queue capacity for print media such as, but not limited to, print literature of medication prescription orders can be achieved with the continuous print software and associated technology. Embodiments of the continuous print system enable associated printers to operate basically in a mode of continuous printing, continuously having at least one print job in the printer's memory. Hence, print media sheets constantly emit, print job after print job, from the associated printer of a continuous print system. Thus, any warm-up or cool-down cycles of the associated printer that can occur even with slight delay between successive print jobs will be eliminated during normal operation of the continuous print system. Controlled and configurable print cycles allow embodiments of the continuous print system to manage and optimize print speeds through various types of associated printers integrated into the continuous print system and overall pharmacy fulfillment operation.

Features and advantages of the embodiments of the continuous print system include automated queuing methodology that complements the ability to increase the print-ahead function associated with some pharmacy management systems. Proper print-ahead functionality is critical for optimal packing efficiency. Moreover, embodiments of the continuous print system allow the print literature printing process to be matched to the needs of a specific packing system or application. For example, an embodiment continuous print system can be configured for a supertote and regular tote-based semi-automated packing system including print media handling devices required for the various processes therewith.

### Terminology

The terms and phrases as indicated in quotes (“ ”) in this section are intended to have the meaning ascribed to them in this Terminology section applied to them throughout this document including the claims unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive rather the term is inclusive meaning: either or both.

References in the specification to “one embodiment,” “an embodiment,” “an alternative embodiment” and similar phrases mean that a particular feature, structure, or characteristic described in connection with the embodiment is included in at least an embodiment of the invention. The appearances of the phrase “in one embodiment” in various places in the specification are not necessarily all meant to refer to the same embodiment.

The term “couple” or “coupled” as used in this specification and the appended claims refers to either an indirect or direct connection between the identified elements, components or objects. Often the manner of the coupling will be related specifically to the manner in which the two coupled elements interact.

The term “removable,” “removably coupled,” “readily removable,” “threadably coupled,” and similar terms, as used in this specification and appended claims, refer to structures that can be uncoupled from an adjoining structure with relative ease (i.e., non-destructively and without complicated or time consuming process), and can also be readily reattached or coupled to the previously adjoining structure.

Directional and/or relationary terms such as, but not limited to, left, right, top, bottom, vertical, horizontal, back, front and lateral are relative to each other and are dependent on the specific orientation of an applicable element or article, and are used accordingly to aid in the description of the various embodiments and are not necessarily intended to be construed as limiting.

As applicable, the term “about,” as used herein unless otherwise indicated, means a margin of plus or minus 20%. Also, as applicable, the term “approximately,” as used herein unless otherwise indicated, means a margin of plus or minus 10%. Concerning angular measurements, “about” refers to plus or minus 10 degrees, and “approximately” refers to plus or minus 5.0 degrees, unless otherwise indicated. It is to be appreciated that not all uses of the above terms are quantifiable such that the referenced ranges can be applied.

The terms “generally” and “substantially,” as used in this specification and appended claims, mean mostly, or for the most part.

### Exemplary Embodiments of a Print Media Handling Device

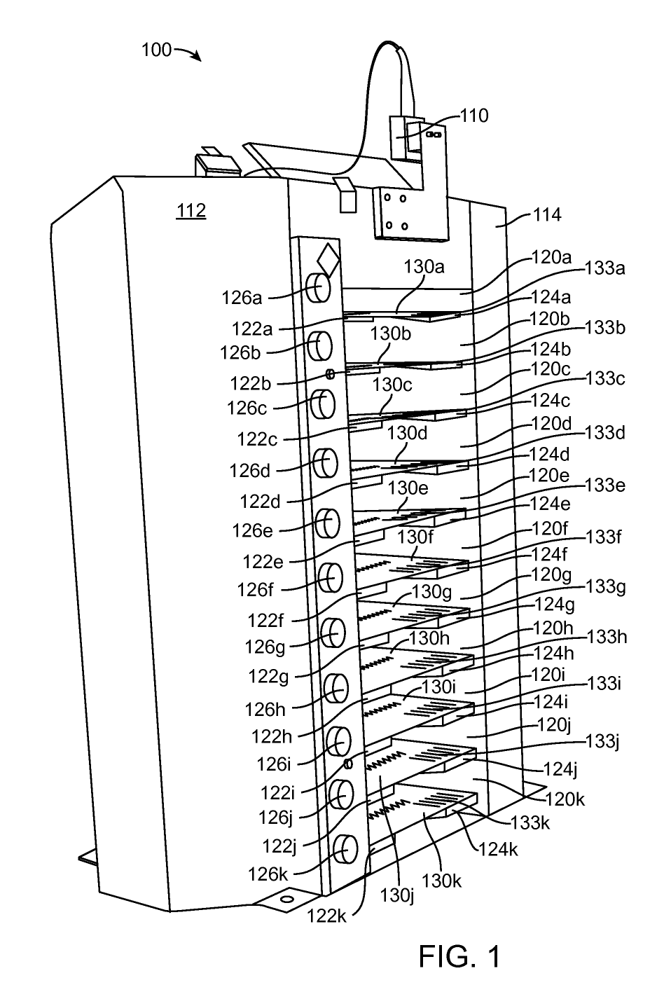

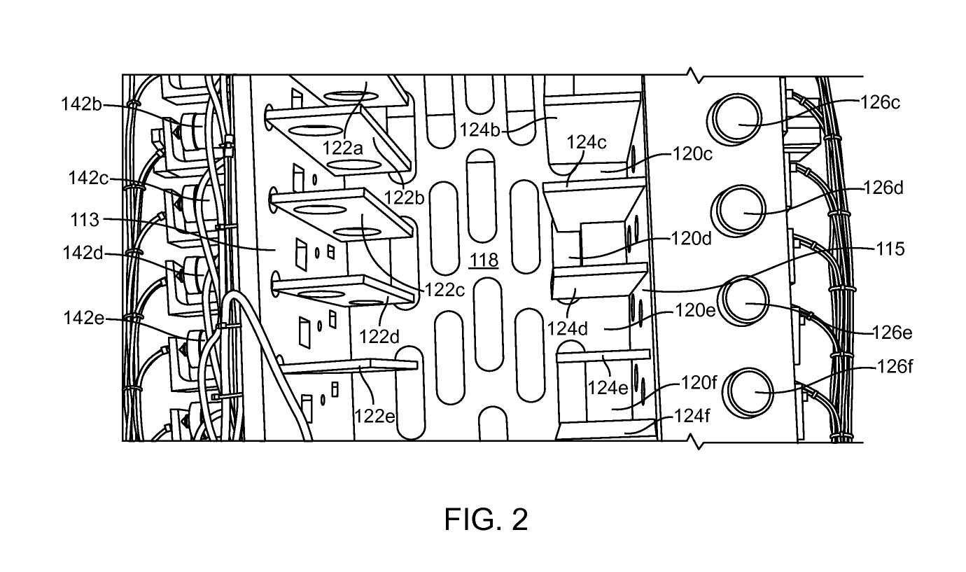

Exemplary embodiments of print media handling devices are illustrated in FIGS. 1 through 5. Referring to FIG. 1, a first embodiment print media handling device 100, which may be referred to as a supertote print media handling device, comprises a support frame having a left side support member 112 and a right side support member 114. The left and right side support members 112, 114 provide structure for the various components of the first embodiment print media handling device 100 and a housing to protect those components and elements. A left side wall 113 is included in the left side support member 112 and a right side wall 115 is included in the right side support member 114 (see FIG. 2). It is to be appreciated that other support structures and general housing features are typically included in the support frame. For example, the first embodiment print media handling device 100 typically includes as back wall 118 (see FIG. 2). The inclusion or exclusion of such structure and features will depend on the particular embodiment of the print media handling device, as will become apparent to one having ordinary skill in the art given the benefit of the entire disclosure.

The first embodiment print media handling device 100 also comprises a plurality of temporary holding sections 120. In at least one version, the first embodiment print media handling device 100 includes 11 temporary holding sections 120a-k. Each of the temporary holding sections 120 are approximately vertically aligned with each other to allow print media to fall from one temporary holding section 120 to a next temporary holding section below when the contents of the next temporary holding section 120 have been cleared. For typical printer speeds and standard order processing/packing timeframes, a print media handling device with eleven temporary holding sections is typically sufficient to keep the printer in active-mode during the packaging process.

It is to be appreciated, however, that various embodiments of the print media handling device may include different numbers of temporary holding sections. As would be apparent one of ordinary skill in the art, the number of temporary holding sections in a given print handling device can be related to the speed of the printer, the average number of print media sheets associated with a typical print order, and the associated order processing timeframes. Embodiments therefore preferably include at least six temporary holding sections, more preferably include between eight and sixteen temporary holding sections, and most preferably include about eleven temporary holding sections.

Referring now to FIG. 2, each of the temporary holding sections 120 typically comprises a left barrier, a right barrier, and a moveable bottom barrier. The left barrier of each temporary holding section 120 is typically defined at least in part by the left side wall 113 of the support frame. Similarly, the right barrier of each temporary holding section 120 is typically defined at least in part by the right side wall 115 of the support frame. The left and right side walls 113, 115 that make up the left and right barriers of the temporary holding sections 120 are typically substantially solid walls. However, in some embodiments the walls can comprise one or more open portions. For example, the left and right side walls may include a plurality of air holes therethrough to allow the print media sheets to cool and/or better overall cooling properties for the first embodiment print media handling device 100.

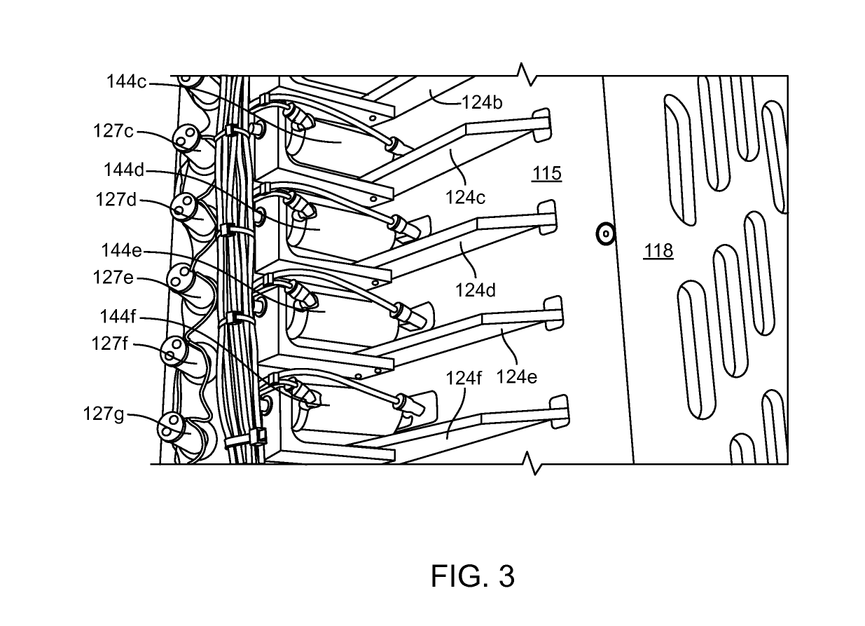

The moveable bottom barrier can be comprised of various structures adapted to remove or eliminate the bottom barrier of each temporary holding section 120 and then reestablish the bottom barrier. In the first embodiment print media handling device 100, the moveable bottom barrier of each temporary holding section 120 includes a pair of generally horizontally-aligned opposing supporting members as described above. However, in at least one embodiment, the temporary holding section can include only a single movable supporting member, for example, where the single movable supporting member extends substantially or completely from one side wall to the other. As can be seen from FIG. 2, a plurality of left side support plates 122 and a plurality of right side support plates 124 can constitute the moveable bottom barriers of the temporary holding sections 120. The left and right side support plates 122, 124 can be operated by actuators. Moreover, the actuators can be pneumatically-operated actuators, and some embodiments included electric actuators comprising, for instance, stepping motors. Corresponding left side actuators 142b-e operatively coupled to left side support plates 122b-e can be seen in FIG. 2 and corresponding right side actuators 144c-f operatively coupled to right side support plates 124c-f can be seen in FIG. 3.

Each of the temporary holding sections 120 of the first embodiment print media handling device 100 also includes an associated indicator light 126 and an open front end to allow an operator to identify and grab the proper print media sheets during operation. However, the topmost temporary holding section typically has a closed front end and no indicator light, as the topmost temporary holding section is typically used for staging purposes only. The plurality of indicator lights 126 can be operated by a plurality of lamps 127 (FIG. 3).

Typically, at least some of the temporary holding sections 120 include a sensing mechanism to determine whether a particular print job comprising one or more print media sheets has been removed or not. Hence, when the operator properly removes all print media sheets from a particular temporary holding section 120, the sensing mechanism will indicate a “clear” status and the continuous print software will deactivate the indicator light 126 and perform the series of steps to traverse the various print jobs down through the temporary holding sections 120. Similarly, when all print media sheets of a print job have properly traversed from a first temporary holding section 120 to a next temporary holding section 120 below, the sensing mechanism will indicate a “clear” status and the continuous print software will activate the print job above the first temporary holding section 120 to traverse or drop therein.

It is to be appreciated that many of the elements illustrated in FIGS. 2 and 3 and described above apply equally to other embodiments of the print media handling device. It is to be further understood that in some embodiments, the temporary holding sections may not be exactly vertically aligned, but can be adjacently angled (e.g., temporary holding sections resembling a sectioning of an angled slide or chute).

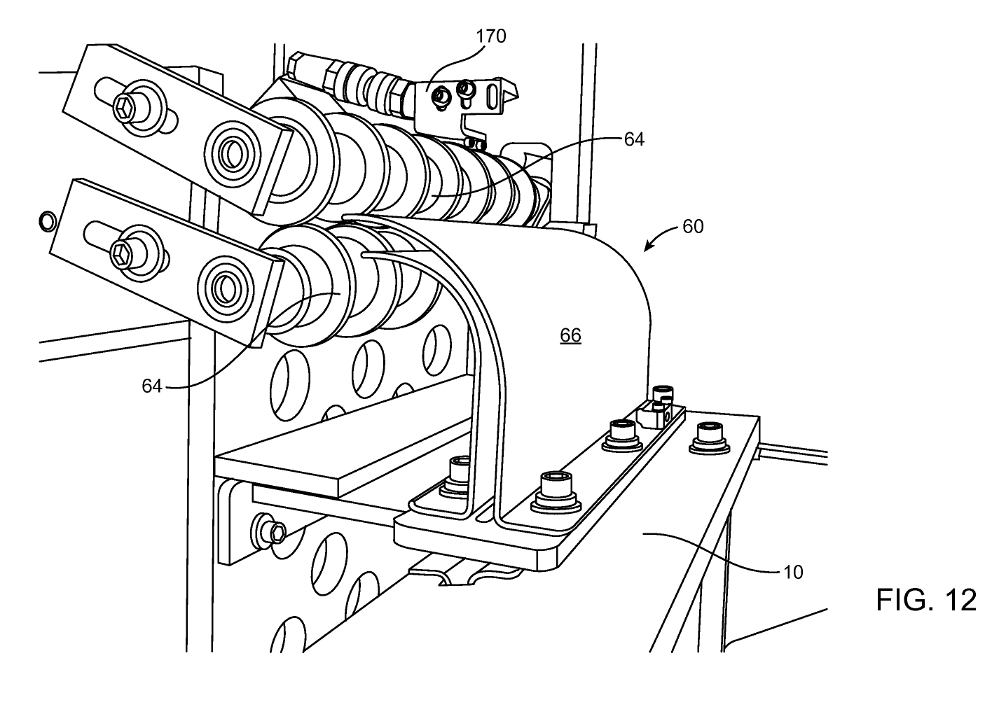

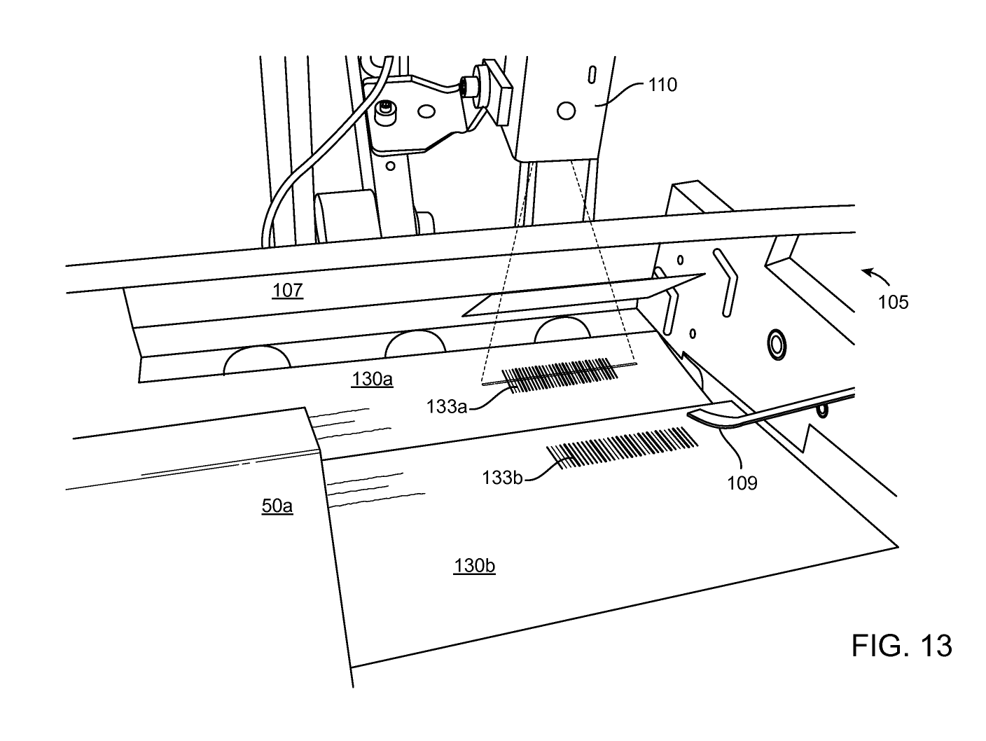

Now with reference to FIG. 13 in addition to FIGS. 1 through 3, a topmost staging area section 105 is described. The topmost staging area section 105 may also be considered a first of the plurality of temporary holding sections in some embodiments. The topmost staging area section 105 receives print media sheets 130 from a printer via a feed mechanism 50a. The topmost staging area section 105 includes at least a first sensor 110 adapted to read a code 133 disposed on at least some print media sheets 130. The first sensor 110 is typically an optical scanner assembly such as, but not limited to, a barcode scanner. The barcode scanner includes a light source, a lens, and an optical sensor. The light source used in the barcode scanner and other optical scanner assemblies can be adapted to transmit visible light, infrared light, and/or ultraviolet light. Similarly, the optical sensor can be adapted to detect visible light, infrared light, and/or ultraviolet light. The topmost staging area section 105 typically also includes a second sensor 170 (FIG. 12) adapted to count print media sheets 130.

Additional features and elements of the topmost staging area section 105 assist in stacking, alignment, and execution of the print jobs. For example, a sheet guide 109 can help to keep the incoming sheet from moving out of alignment with the previously printed sheets such that the resulting print job is neatly stacked prior to being dropped to the next temporary holding section 120. Some variations of the topmost staging area section 105 may include a slightly downward chute portion to ensure that the print media sheet moves enough to properly stack and align at the corner edges of the print media sheets. Moreover, the topmost staging area section 105 can also include a plate 107 that limits area for which the barcode scanner can read on the print media 130. The plate 107 can also serve as a baffle to direct airflow from the movement of the print media sheets toward the corner edges. Such airflow direction can facilitate proper stacking of the print media sheets.

In any one given unique set document, the code 133 used to identify the unique set document should be disposed on at least one (but more typically some or all) of the print media sheets comprising the unique set document that is the specific print order.

It is pertinent to note that embodiments of the topmost staging area section 105 may not include the second sensor 170 for counting print media sheets because in some instances information determining when a specific print job has been completed can be ascertained by the first sensor 110. For example, the code or indicia 133 on the last print media sheet in a print job may include an embedded code that indicates it is the last print media sheet in the current print job.

One of many features of the continuous print software is that activation of the movable bottom barrier can be initiated or controlled very quickly. Hence, the bottom barrier can be removed from a temporary holding section 120 for an interval just long enough for the print media sheets 130 to traverse (typically a drop traverse) to the next lower temporary holding section 120. Then, the bottom barrier can be reestablished extremely quickly. This is particularly advantageous in the context of the topmost staging area section 105 or topmost temporary holding section because sheets from different print jobs exit a high speed printer contiguously at rapid rates without any pause between consecutive print jobs.

The movable bottom barrier that holds the print media sheets 130 within a temporary holding section 120 can be removed and reestablished almost instantaneously. For example, the moveable bottom barrier of the topmost staging area section 105 is activated after sensing a last print media sheet of a first print job 130a. The sensing of the last print media sheet can be determined by counting the number of sheets and/or an indication embedded in the code or indicia 133a thereon as provided by the first and second sensors 110, 170 of the topmost staging area section 105. Once the last print media sheet of the first print job 130a has been identified, the first print job is traversed or dropped into a next adjacent lower temporary holding section (temporary holding section 120a referring back to FIG.1). This occurs while a first print media sheet of a second print job 130b is operatively engaged with the feed mechanism 50a.

As can be seen from the illustration in FIG. 13, the first print media sheet of the second print job 130b will still be grasped by the rollers of the feed mechanism 50a when the bottom barrier is removed from the topmost staging area section 105. Thus, the first sheet of the second print job 130b can be virtually hanging over the topmost staging area section 105 when the first print job 130a is traversed or dropped to the temporary holding section below.

After the first print job 130a traverses or drops into the temporary holding section below, the moveable bottom barrier again quickly (in a fraction of a second in some embodiments) restores the bottom barrier by the time the first print media sheet of the second print job 130b disengages with the feed mechanism 50a and enters into the topmost staging area section 105. Hence, continuous printing of print media sheets and the associated print jobs is achieved by the first embodiment continuous print device and continuous print software.

As will be apparent to one having ordinary skill in the art given the benefit of this entire disclosure, various embodiments of the continuous print technology can be employed for various situations, and are contemplated herein. For example, a single large print job including sheets having indicia or codes adapted to indicate separation of parts in the entire job can be sent to the printer and parsed out or separated by embodiments of the print media handling device, in a similar fashion as described above. In such a variation, of course, the last print media sheet is of a first division or partition of the single large print job and the first print media sheet will be of the second division or partition of the single large print job.

Variations of the first print media handling device shown in FIGS. 1 through 3 can be referred to as having an “S” or “S-Box” configuration adapted for use with supertotes. The S or S-Box configuration enables so-called “pick-to-light” operation, wherein an operator scans or otherwise reads indicia residing on a medication container in a supertote or retrieved therefrom. Data associated with the indicia is subsequently transmitted to the print media handling device, whereupon an indicator light residing next to a temporary holding section containing a print job associated with the medication container is illuminated. The operator is thus instructed which print job to pick in order to pack or otherwise combine the print job with the medication container. The first print media handling device can also be used in association with medication vials or bottles.

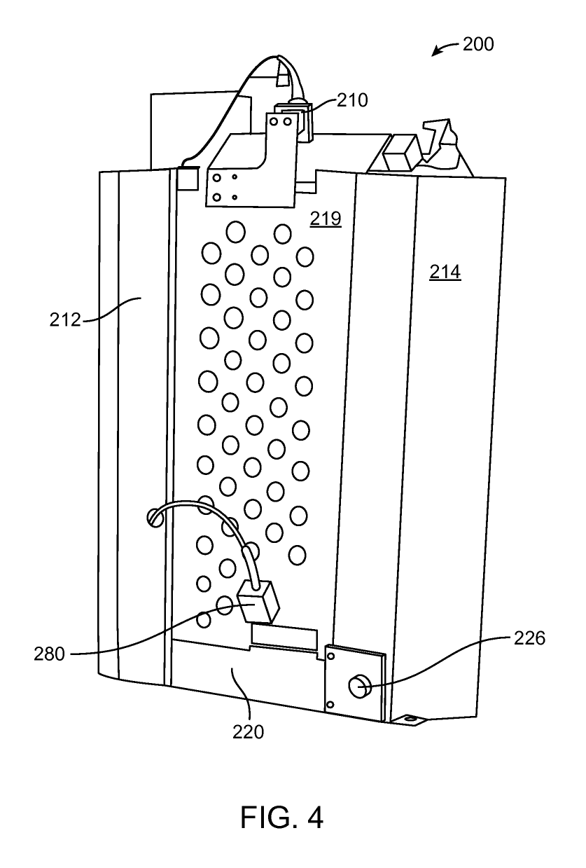

FIG. 4 illustrates a second embodiment print media handling device 200. The second embodiment print media handling device 200 has a left side support member 212 and a right side support member 214. However, the second embodiment print media handling device 200 further includes a front wall 219. The front wall 219 covers all temporary holding sections except a bottommost temporary holding section 220, which has an open front end. The second embodiment print media handling device 200 further includes an indicator light 226 to identify when a print job resides in the bottommost temporary holding section 220. The second embodiment print media handling device 200 typically also has a third sensor 280, which acts as a redundancy check for the first sensor.

Variations of the second print media handling device shown in FIG. 4 can be referred to as having a “P” or “P-Box” configuration. The P configured print media handling device is typically, but not necessarily, used with regular single totes and employs a first in—first out (FIFO) method of identifying which print jobs are associated with which medication containers. In the FIFO method, the print job first delivered to the bottommost temporary holding section 220, and thus first available for an operator to retrieve, is typically associated with the medication container(s) first delivered or otherwise first available to the operator. Print jobs generally arrive in the bottommost temporary holding section in the order they are printed, which corresponds to the order in which medication containers are delivered to the operator. The second print media handling device can also be used with vials or bottles.

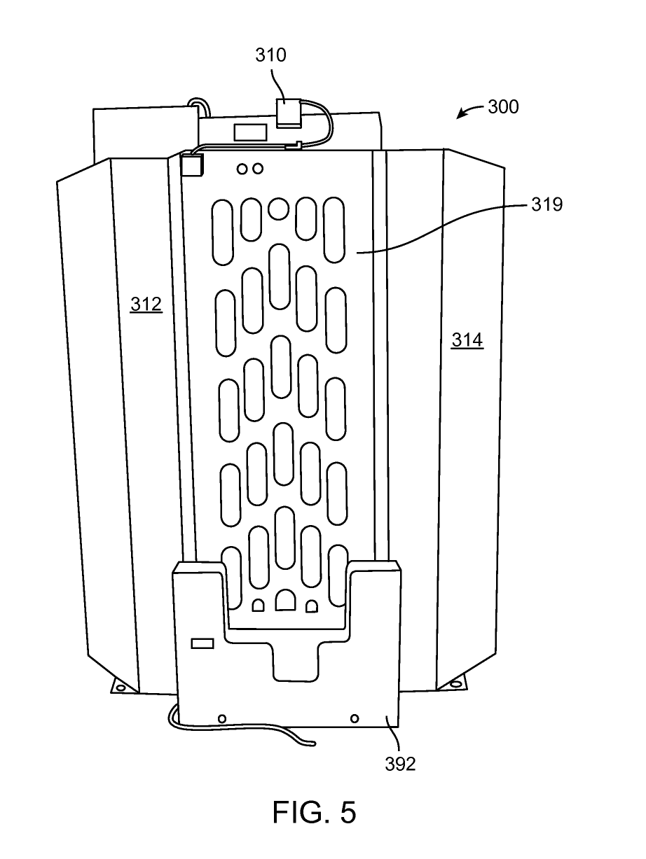

Referring now to FIG. 5, a third embodiment print media handling device 300 is shown. The third embodiment print media handling device 300 similarly has a left side support member 312 and a right side support member 314. Like the second embodiment, the third embodiment print media handling device 300 further includes a front wall 319. The front wall 319 covers all temporary holding sections except a bottommost temporary holding section (not shown), which has an open front end that is operatively engaged to a feed guide or similar mechanism that transfers the print job from the bottommost temporary holding section to a folding assembly. After operation of the folding assembly, the folded print order can be retrieved by the operator at a folding assembly egress point 392.

Variations of the third print media handling device shown in FIG. 5 can be referred to as having an “R” or “R-Box” configuration. The R configured print media handling device is typically, but not necessarily, used with regular single totes and employs a FIFO method of identifying which particular print job is associated with which medication container(s). The print job is typically presented to an operator after it is folded and scanned, and thus ready for combination with a medication container for subsequent delivery to a customer. The third embodiment print media handling device can also be used with vials or bottles.

### An Exemplary Continuous Print System

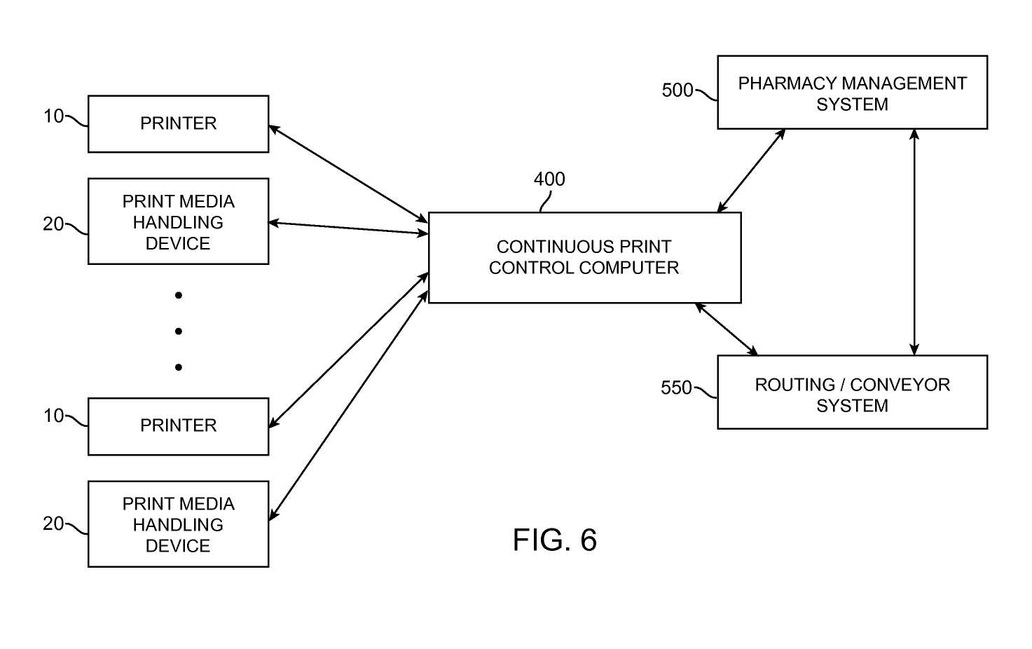

FIG. 6 is a block diagram illustrating an exemplary architecture of a continuous print system according to an embodiment. The exemplary continuous print system continuously prints unique set documents related to fulfillment of pharmacy medication prescription orders. Each unique set document is associated to at least one specific medication container of a prescription order. For the sake of brevity, conventional data networking applications and other computer science functional embodiments of the system and components thereof may not be described in significant detail herein as would be obvious to one of ordinary skill in the art.

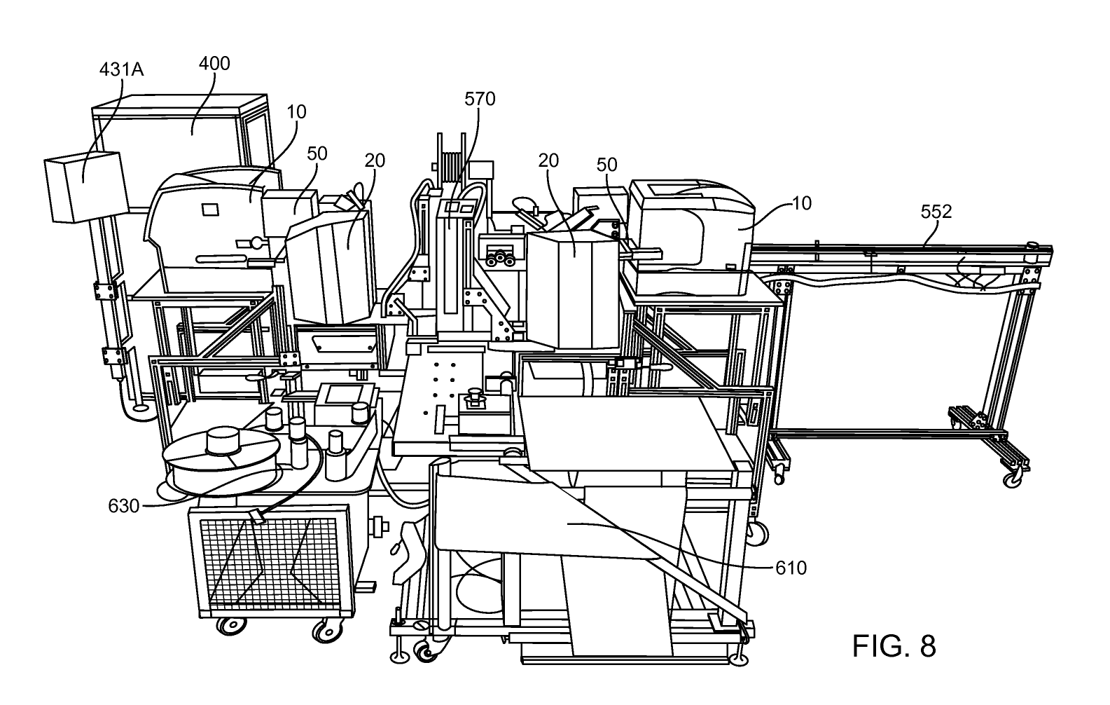

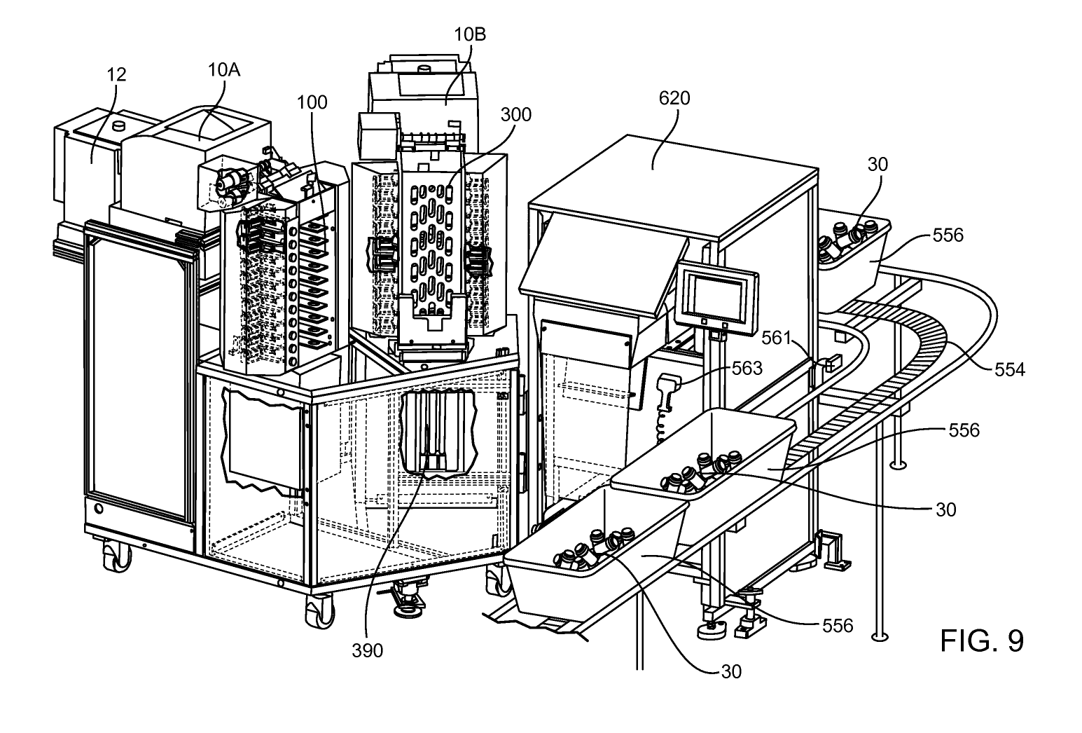

Reference is also made to FIGS. 8 through 12 illustrating various embodiments of fully and semi-automated continuous print systems. Continuous print control computer 400 is electronically coupled to a pharmacy management system 500 and configured to receive a plurality of print jobs therefrom. The continuous print control computer 400 is also typically electronically coupled to a routing/conveyor system 550, particularly an infeed portion thereof. Additionally, a tote scanner 561 is electronically coupled to the continuous print control computer 400. The tote scanner 561 (FIG. 9) is for scanning a plurality of totes 556. Each tote has a tote indicia including at least a tote type designation and a medication container association. A medication container scanner 563 (FIG. 9) is also electronically coupled to the continuous print control computer 400. The medication container scanner 563 can be handheld, but is more typically a stationary unit so that the operator can swipe the medication containers 30 thereunder. Each medication container has a medication container indicia including at least a print job association.

The continuous print control computer 400 is electronically coupled to one or more printers 10 and each corresponding one or more print media handling device 20. For example, a first printer can be electronically coupled to the continuous print control computer 400. A supertote print media handling device can be operatively coupled to the first printer and electronically coupled to the continuous print control computer 400. The super tote print handling device can comprise: a support frame including at least a left side wall and a right side wall, a topmost staging area section including a first sensor adapted to count print media sheets and a second sensor adapted to read a code disposed on at least some print media sheets, a plurality of temporary holding sections, each temporary holding section being disposed below the topmost staging area section, being approximately vertically aligned with the each other, and comprising a left barrier defined by the left side wall, a right barrier defined by the right side wall, a moveable bottom barrier, an open front end, and a indicator light, and a reject section.

The reject section is typically a substantially enclosed compartment disposed beneath the bottommost temporary holding section. Hence, any rejected orders can be dropped into the reject section or reject box. Moreover, an operator cannot access the rejected print media therein in order to avoid any handling errors and provide customer privacy measures. However, some embodiments are contemplated where the reject section is accessible to the operator. In contrast, other embodiments are contemplated where the reject section is operatively coupled to a shredding device to provide enhanced customer privacy measures.

The continuous print control computer 400 is adapted to send a plurality of print jobs, and to track each print job until the print job is packed with its associated medication container or containers. The continuous print software associates and tracks each medication container 30 from a tote 556 with its associated print literature that is processed as a print job through the one or more print media handling devices 20.

Implementations of the continuous print control computer 400 may include receiving a first print job from the pharmacy order management system 500 after which the control computer 400 stores the print information for the first print job, identifies the first print job as being from a supertote from the tote type designation, and sends a first print job request to the first printer. Also, the control computer 400 may designate the first print job as valid if the proper number of sheets has been verified, or rejected if not.

Various embodiments of fully and semi-automated continuous print systems are illustrated and described as follows. FIG. 8 is a perspective view of an exemplary continuous print system with a print media handling device in a fully-automated bottle/vial-based medication packing station according to an embodiment. The fully-automated bottle/vial-based medication packing station includes a bottle/vial infeed conveyor 552, an automated packaging feed system 610, and a downward-facing folding assembly 570 for directing print literature into an awaiting package.

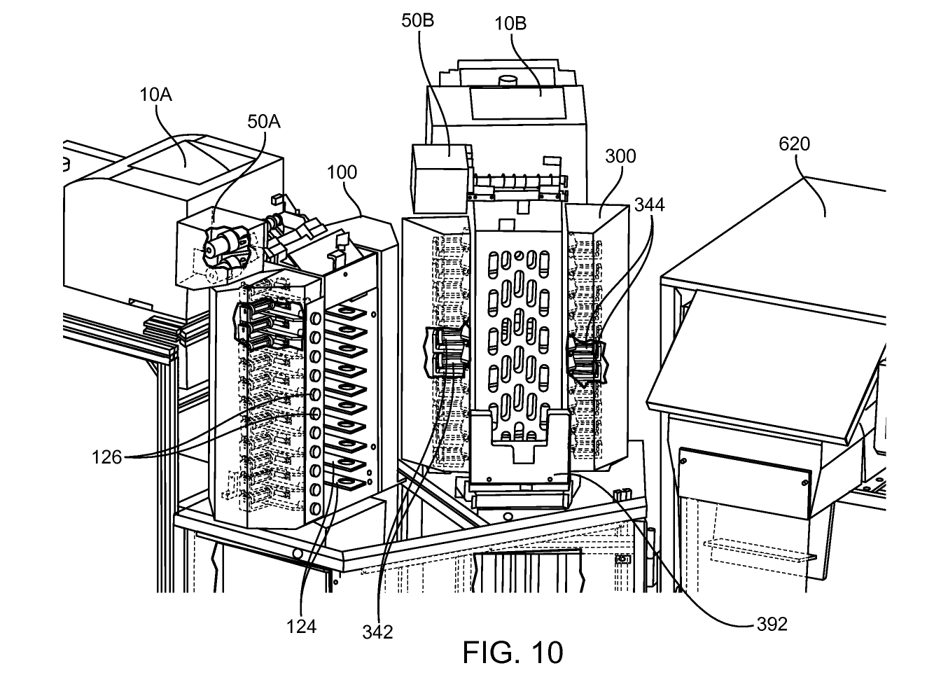

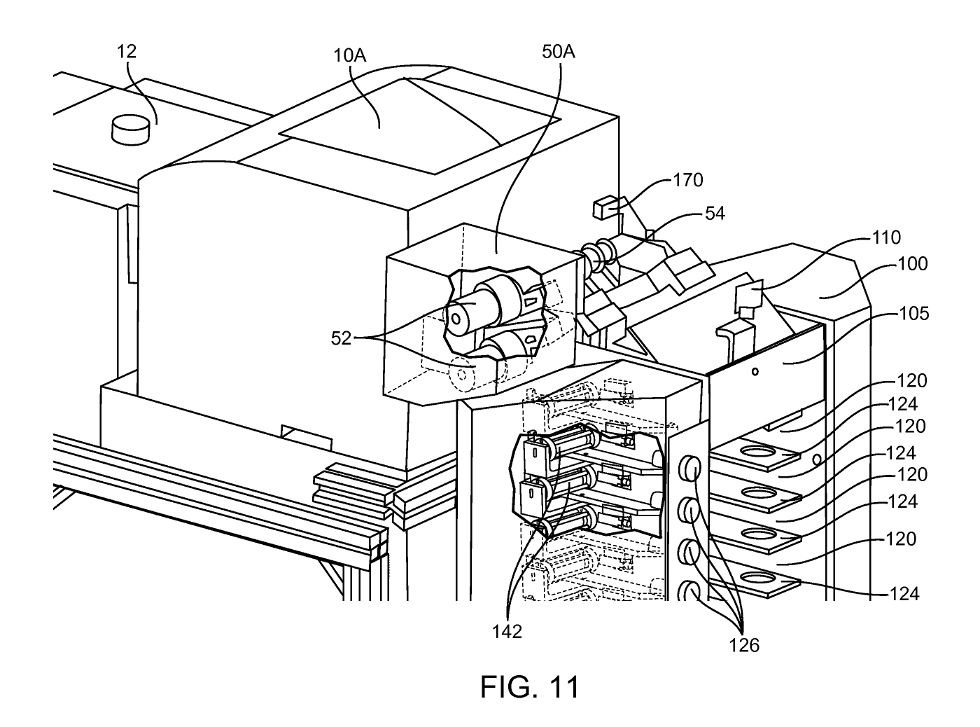

FIG. 9 is a perspective view of an exemplary continuous print system with two print media handling devices in a regular tote/supertote-based semi-automated medication packing station according to an embodiment. The semi-automated medication packing station includes a packaging station 620, a tote infeed conveyor 554, an upward-facing folding assembly 390, and a sheet feeder 12 operatively coupled to the printer 10A. FIG. 10 is a close-up perspective view of the two print media handling devices in the exemplary continuous print system illustrated in FIG. 9. FIG. 11 is a close-up perspective view of a feed mechanism 50a showing its feed motors 52 and feed rollers 54.

The exemplary continuous print system illustrated in FIG. 9 includes both an S-Box configured print media handling device 100 and an R-Box configured print media handling device 300. Accordingly, the system is adapted for both pick-to-light operation that typically, but not necessarily uses supertotes for holding medication containers, and for FIFO operation using regular single totes. The exemplary continuous print system illustrated in FIG. 9 can also be adapted to use with vials or bottles.

FIG. 12 is a close-up perspective view of an alternative feed mechanism 60 according to an embodiment. A channel is formed in the print media sheet guide 66 that directs a print media emitted upwardly from the printer 10 so that it engages with the feed rollers 64 of the alternative feed mechanism 60.

Embodiments of continuous print systems can continuously generate print jobs during fulfillment of prescription orders without associated laser printers going into standby mode. The continuous print system can preferably generate at least 11 unique print jobs, more preferably at least 300 unique print jobs, still more preferably at least 600 unique print jobs, and most preferably at least 2400 unique print jobs, without an associated laser printer going into standby mode during fulfillment of prescription orders.

Similarly, laser printers associated with continuous print systems can run continuously for long periods of time during fulfillment of prescription orders without going into standby mode. The associated laser printers can run continuously during fulfillment of prescription orders for preferably at least 15 minutes, more preferably at least 60 minutes, and most preferably at least 240 minutes, without going into standby mode.

### An Exemplary Computer System

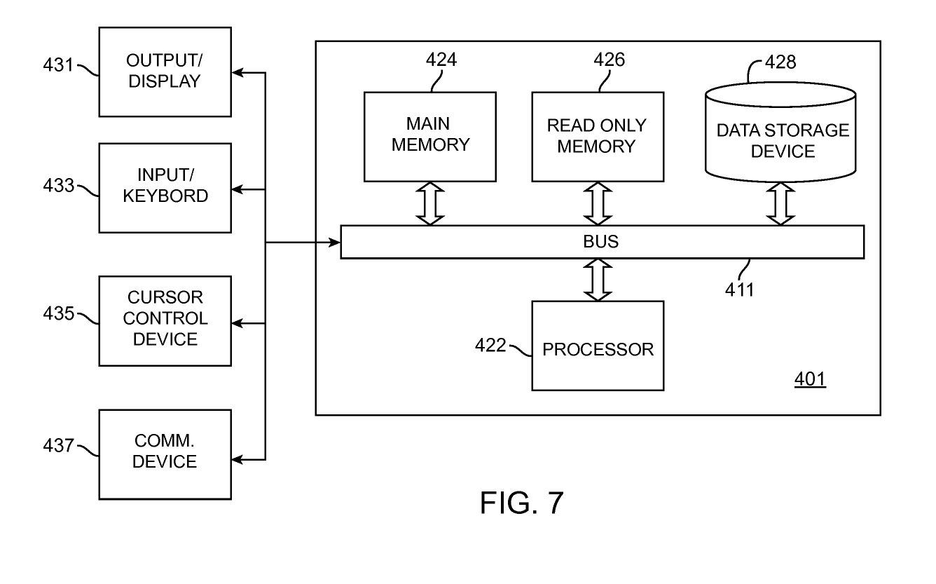

Now referring to FIG. 7, the block diagram of an exemplary general purpose computer system for use as a continuous print control computer 400 is illustrated. It is to be appreciated that embodiments of the print media handling device including the first, second, and third embodiment print media handling device 100, 200, 300 can be electrically coupled to and controlled by the continuous print control computer. Additionally, other computer systems and devices can by electrically coupled to and controlled by the continuous print control computer as necessary to implement the various processes and methods disclosed herein.

Computer system 401 is an exemplary general purpose computer system upon which embodiments of the present invention can be implemented. Computer system 401 typically comprises a bus or other communications means 411 for communicating data or information, and a processing means such as a processor 422. The computer system 401 further comprises a random access memory (RAM) or other similar dynamically-generated data storage device 424 (referred to as main memory in FIG. 7 and hereinafter). Main memory 424 is coupled to the bus 411 for storing information and instructions to be executed by the processor 422. Additionally, the main memory 424 can be used for storing temporary variables or other intermediate information during execution of instructions by the processor 422.

Computer system 401 also comprises a read only memory (ROM) and/or other static storage device 426 coupled to the bus 411 for storing static information and instructions for the processor 422. A data storage device 428 such as, but not limited to, a solid state drive or an optical disk drive can also be coupled to the bus 411 as a component of the computer system 401 for storing data and instructions.

A plurality of devices can be coupled to computer system 401 via the bus 411. An output or display device 431, such as but not limited to a cathode ray tube (CRT) on liquid crystal display (LCD) may be provided for displaying information to a user. Typically, an input device 433 such as an alphanumeric keyboard, including alphanumeric, symbol, and other keys can be coupled to the bus 411 for communicating information and/or command selections to the processor 422. Another type of user input device, such as a mouse, trackball, or cursor direction keys 435 for communicating information and/or command selections to the processor 422 can be utilized for controlling cursor movement on the display device 431.

Moreover, computer system 401 can also include a communications device 437 or interface operatively coupled via the bus 422 allowing data and/or software to be transferred between computer system 401 and external networks and devices. Examples of communications devices 437 include, but are not limited to a modem, a network interface card, a wireless network interface card, a serial concentrator, or other well-known interface device, such as those used for Ethernet, token ring, asynchronous transfer mode (ATM), or other types of physical attachment for purposes of providing a communications link to support a local or wide area network. In this manner, computer system 401 can be coupled to one or more order entry or information systems, such as those used by a pharmacy or other medication administration entity via a conventional network infrastructure, such as and intranet and/or the Internet, for example. It is appreciated that a lesser or more equipped computer system than the example described above can be desirable for certain implementations of the system of the present invention. Therefore, the configuration of the computer system 401 will vary from implementation to implementation depending on numerous factors such as price constraints, performance requirements, technological improvements, and/or other circumstances.

It is pertinent to note that, while the operation described herein can be performed under the control of a programmed processor, such as the processer 422 in FIG. 24, in alternative embodiments, the operations can be fully or partially implemented by any programmable or hard-coded logic, such as but not limited to field programmable gate arrays (FPGAs), TTL logic, application specific integrated circuits (ASICs), for example.

Additionally, the exemplary methods of the embodiments can be performed by any combination of programmed general purpose computer components and/or custom hardware components. Therefore, nothing disclosed herein should be construed as limiting the present invention to a particular embodiment wherein the recited operations are performed by a specific combination of hardware components. As would be obvious to one skilled in the art of computer science and systems engineering, many variations and alternate embodiments of the systems described above can be used with embodiments of the present invention. The plurality of systems and software modules can be stored in any one of a number of internal and external storage devices, remotely or centrally located, as those of skill in the art could easily adapt one embodiment computer architecture to a multitude of embodiments. Furthermore, a system for making, using, or selling the embodiments can be one or more processing systems including, but not limited to, servers, a central processing unit, memory, storage devices, input/output devices, communication links and devices, or any modules or components of the one or more processing system including by way of example, but not limitation, software, firmware, hardware, or any combination thereof.

### Alternative Embodiments and Variations

The various embodiments and variations thereof, illustrated in the accompanying figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention disclosed in this application are intended and contemplated to be within the spirit and scope of the invention.

I claim:

1. A print media handling device comprising:
a support frame including at least a left side wall and a right side wall;
a plurality of temporary holding sections, each temporary holding section being approximately vertically aligned with each other and comprising,
a left barrier defined by the left side wall,
a right barrier defined by the right side wall, and
a moveable bottom barrier;
wherein a topmost temporary holding section includes a first sensor adapted to read a code disposed on at least some print media sheets.

2. The print media handling device of claim 1, further comprising a reject section disposed below a bottommost temporary holding section and being approximately vertically aligned therewith.

3. The print media handling device of claim 1, wherein the moveable bottom barrier comprises a pair of generally horizontally-aligned opposing supporting members operatively coupled to actuators.

4. The print media handling device of claim 1, wherein the first sensor includes a barcode scanner.

5. The print media handling device of claim 1, wherein a bottommost temporary holding section includes an open front end and all other temporary holding sections include closed front ends.

6. The print media handling device of claim 5, wherein the bottommost temporary holding section further includes an indicator light.

7. The print media handling device of claim 5, further comprising a folding assembly operatively coupled to the open front end of the bottommost temporary holding section.

8. The print media handling device of claim 1, wherein the topmost temporary holding section includes a closed front end and all other temporary holding sections include open front ends and indicator lights.

9. The print media handling device of claim 1, wherein the plurality of temporary holding sections comprises six or more temporary holding sections.

10. The print media handling device of claim 1, wherein the plurality of temporary holding sections comprises eleven of more temporary holding sections.

11. The print media handling device of claim 2, wherein the plurality of temporary holding sections are adapted to traverse a print order from the topmost temporary holding section through a series of adjacent lower temporary holding sections to one of (i) a temporary holding section associated with a specific medication container, (ii) the bottommost temporary holding section, and (iii) the reject section.

12. The print media handling device of claim 1, further comprising a feed mechanism adapted to transport a print media sheet from an egress portion in a printer to an ingress portion in the topmost temporary holding section.

13. The print media handling device of claim 12, wherein the moveable bottom barrier of the topmost temporary holding section is activated after sensing a last print media sheet of a first print job thereby traversing the first print job to a next adjacent lower temporary holding section while a first print media sheet of a second print job is operatively engaged with the feed mechanism.

14. The print media handling device of claim 1, further comprising a second sensor adapted to count print media sheets.

15. A method of using the print media handling device of claim 1 comprising:
delivering a first print media sheet into the topmost temporary holding section;
reading a code disposed on the first print media sheet;
removing the bottom barrier from below the first print media sheet;
traversing the first print media sheet from the topmost temporary holding section into at least one of the temporary holding sections residing below the topmost temporary holding section;
reestablishing the moveable bottom barrier at a bottom of the topmost temporary holding section; and
delivering a second print media sheet into the topmost temporary holding section.

16. The method of using the print media handling device of claim 11, further comprising:
transporting a last print media sheet of a first print job from and an egress portion in a printer to an ingress portion in the topmost temporary holding section prior to delivering the last print media sheet into the topmost temporary holding section;
sensing the last print media sheet in the topmost temporary holding section;
activating the moveable bottom barrier and traversing the first print job from the topmost temporary holding section to the next adjacent lower temporary holding section while a first print media sheet of a second print job is operatively engaged with the feed mechanism;
transporting the first print media sheet of the second print job from the egress portion to the ingress portion; and
delivering the first print media sheet into the topmost temporary holding section.

17. The method of claim 16, further comprising sequentially traversing the first print job into each temporary holding section, wherein the plurality of temporary holding sections comprises at least eleven temporary holding sections.

19. A method of using the print media handling device of claim 11 comprising traversing a print order from the topmost temporary holding section through a series of adjacent lower temporary holding sections to one of (i) a temporary holding section within which the print order resides until removal for combination with an associated medication container, (ii) the bottommost temporary holding section, and (iii) the reject section.

20. A system for continuously printing unique set documents related to fulfillment of pharmacy medication prescription orders whereby each unique set document is associated to at least one specific medication container of a prescription order, the system comprising:
a control computer electronically coupled to a pharmacy management system and configured to receive a plurality of print jobs therefrom;
a tote scanner for scanning a plurality of totes, the tote scanner being electronically coupled to the control computer and each tote having a tote indicia including at least a tote type designation and a medication container association;
a medication container scanner electronically coupled to the control computer, the medication container scanner for scanning a plurality of medication containers, each medication container having a medication container indicia including at least a print job association;
a first printer electronically coupled to the control computer; and
a supertote print media handling device operatively coupled to the first printer and electronically coupled to the control computer, the super tote print handling device comprising,
a support frame including at least a left side wall and a right side wall,
a topmost staging area section including a first sensor configured to count print media sheets and a second sensor configured to read a code disposed on at least some print media sheets,
a plurality of temporary holding sections, each temporary holding section being disposed below the topmost staging area section, being approximately vertically aligned with each other, and comprising a left barrier defined by the left side wall, a right barrier defined by the right side wall, a moveable bottom barrier, an open front end, and a indicator light, and
a reject section;
wherein the control computer is configured to send a plurality of print jobs and track each of the plurality of print jobs until the each of the plurality of print jobs is packed with its associated at least one medication container.
